(19) United States
(12) Patent Application Publication
(10) Pub. No.: US 2025/0121277 A1
(43) Pub. Date: Apr. 17, 2025

(54) APPARATUS AND METHOD FOR SUPPORTING VIRTUAL GOLF, AND COMPUTER PROGRAM

(71) Applicant: Dae Je CHIN, Seoul (KR)

(72) Inventors: Dae Je CHIN, Seoul (KR); Sang Kook CHIN, Seoul (KR)

(73) Assignee: Dae Je CHIN, Seoul (KR)

(21) Appl. No.: 18/900,663

(22) Filed: Sep. 28, 2024

(30) Foreign Application Priority Data
Oct. 16, 2023 (KR) 10-2023-0138049

(51) Int. Cl. A63F 13/213; A63F 13/812

(52) U.S. Cl. CPC A63F 13/213; A63F 13/812

(57) ABSTRACT

An apparatus for supporting virtual golf according to one aspect of the present invention includes a golf environment simulation device implemented such that a golf ball is physically hit and moved by to the hit, an image acquisition module configured to acquire an image of the golf ball, and a processor configured to recognize the golf ball based on the image of the golf ball acquired by the image acquisition module at a time point when the golf ball is hit on the golf environment simulation device to determine an initial speed and moving direction of the golf ball, determine a moving trajectory of the golf ball based on a hitting position at which the golf ball is hit and the determined initial speed and moving direction in a virtual play environment, and display the determined moving trajectory.

### CROSS-REFERENCE TO RELATED APPLICATION

The present application claims priority and the benefit of Korean Patent Application No. 10-2023-0138049, filed on Oct. 16, 2023 in the Korean Intellectual Property Office, the entire disclosure of which is incorporated herein by reference.

### BACKGROUND

### 1. Field of the Invention

The present invention relates to an apparatus and method for supporting virtual golf, and a computer program.

### 2. Discussion of Related Art

Golf is a game in which a golf ball is hit at a tee box on a course and ultimately is putted into a hole cup in the green. To hole out with the golf ball into a given hole with the fewest strokes, a golfer studies the terrain of a course and imagines a trajectory of the golf ball flying and rolling in his or her mind according to a speed and moving direction of the golf ball each time the golfer hits the golf ball. Since individuals of the general public imagine the trajectory of a golf ball based on his or her experience, there are frequent cases where an actual moving trajectory and final landing position of the golf ball significantly differ from a trajectory and position expected by the golfer.

Conventional simulation devices, which are devices that provide a simulation of a trajectory of a golf ball, are widely applied to indoor screen golf, and the corresponding device operates in a manner of detecting a speed, a direction, etc., when a golfer hits a golf ball toward a screen and displaying a trajectory of the golf ball on the screen. However, since the above-described golf simulation device is an expensive device distributed for commercial purposes and requires large-scale facilities, there is a limitation that individuals cannot use the device on an actual field.

Therefore, there is a need for an economical and efficient method and system that allow an individual to easily check the trajectory of a golf ball in a small space such as the individual's home while using a portable device such as the individual's mobile phone.

### SUMMARY OF THE INVENTION

The present invention is directed to providing an apparatus and method for supporting virtual golf, and a computer program, which allow an individual to easily check a trajectory formed by hitting a golf ball in a small space such as the individual's home while using a portable device such as the individual's mobile phone to practice golf, and at the same time, many users to enjoy a virtual golf game, and a computer program.

An apparatus for supporting virtual golf according to one aspect of the present invention includes a golf environment simulation device implemented such that a golf ball is physically hit and moved by the hit, an image acquisition module configured to acquire an image of the golf ball, and a processor configured to recognize the golf ball based on the golf ball image acquired by the image acquisition module at a time point when the golf ball is hit on the golf environment simulation device to determine an initial speed and moving direction of the golf ball, determine a moving trajectory of the golf ball based on a hitting position at which the golf ball is hit and the determined initial speed and moving direction in a virtual play environment for the virtual golf for a user, and display the determined moving trajectory.

The processor may perform an environment setting operation of setting the virtual play environment, a position setting operation of setting a hitting position at which a golf ball is hit and a target position at which the golf ball reaches in the set virtual play environment, a speed and moving direction determining operation of recognizing the golf ball through a pre-learned deep learning model based on the image of the golf ball acquired by the image acquisition module at the time point when the golf ball is hit on the golf environment simulation device to determine the initial speed and moving direction of the golf ball, a trajectory determining operation of applying the hitting position, and the initial speed and moving direction to a predefined moving trajectory model to determine the moving trajectory of the golf ball, and a displaying operation of superimposing and displaying the determined moving trajectory on the virtual play environment.

The processor may further perform a position re-setting operation of re-setting a final point of the moving trajectory determined according to the trajectory determining operation as a new hitting position in the virtual play environment in the case of no separate manipulation of the user, and the processor may re-perform the speed and moving direction determining operation, the trajectory determining operation, and the displaying operation after performing the position re-setting operation.

When the position re-setting operation, and the speed and moving direction determining operation, the trajectory determining operation, and the displaying operation that are performed after the position re-setting operation are defined as one operation cycle, the processor may repeatedly perform the operation cycle until the golf ball reaches the target position in the case of no separate manipulation of the user.

The processor may calculate the initial speed and moving direction of the golf ball required for the golf ball to reach the target position from the hitting position based on the target position set according to the position setting operation and the moving trajectory model, and then provides the calculated initial speed and moving direction to the user.

The processor may provide the user with a distance difference and direction between the target position and a final point of the moving trajectory determined according to the trajectory determining operation.

The processor may support a training mode in which one user practices golf and a game mode in which multiple users play a virtual golf game.

The game mode may correspond to a mode in which the multiple users located at remote positions play the virtual golf game based on the golf environment simulation device and the image acquisition module provided at a position of each user, and the processor may record scores, which are calculated as the multiple users play the virtual golf game, for each of the multiple users.

The image acquisition module may include a stereo camera, and the processor may be mounted on a smartphone and acquires three-dimensional position coordinates of the golf ball acquired by the stereo camera through wired or wireless communication to determine the initial speed and moving direction.

A user manipulation command and a result of shot in a golf practice and game may be provided as voice.

The present invention provides a method of supporting virtual golf for a user based on a golf environment simulation device performed by a computing device and implemented such that a golf ball is physically hit and moved by the hit, which includes setting a virtual play environment of the virtual golf, setting a hitting position at which the golf ball is hit and a target position at which the golf ball reaches in the set virtual play environment, recognizing the golf ball through a pre-learned deep learning model based on an image of the golf ball acquired at a time point when the golf ball is hit on the golf environment simulation device, analyzing an afterimage of the image of the golf ball to determine an initial speed and moving direction of the golf ball, applying the hitting position, and the initial speed and moving direction to a predefined moving trajectory model to determine a moving trajectory of the golf ball, and displaying the determined moving trajectory.

A computer program according to one aspect of the present invention is coupled to hardware and stored in a computer-readable recording medium to execute setting a virtual play environment of virtual golf, setting a hitting position at which a golf ball is hit and a target position at which the golf ball reaches in the set virtual play environment, recognizing the golf ball through a pre-learned deep learning model based on an image of the golf ball acquired at a time point when the golf ball is hit on a golf environment simulation device to determine an initial speed and moving direction of the golf ball, wherein the golf environment simulation device is a device implemented such that the golf ball is physically hit and moved by the hit, applying the hitting position, and the initial speed and moving direction to a predefined moving trajectory model to determine a moving trajectory of the golf ball, and displaying the determined moving trajectory.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIGS. 1 and 2 are exemplary views showing an apparatus for supporting virtual golf according to the present embodiment;

FIGS. 3 and 4 are exemplary views showing a user interface (UI) displayed through a user terminal in the apparatus for supporting virtual golf according to the present embodiment;

FIG. 5 is a flowchart showing a method of supporting virtual golf according to the present embodiment; and

FIGS. 6 to 8 are a flowchart and exemplary views for describing a process of determining a moving trajectory of a golf ball in the apparatus for supporting virtual golf according to the present embodiment.

### DETAILED DESCRIPTION OF EXEMPLARY EMBODIMENTS

Hereinafter, embodiments of an apparatus and method for supporting virtual golf, and a computer program according to the present invention will be described with reference to the accompanying drawings. In this process, thicknesses of lines, sizes of components, or the like illustrated in the drawings may be exaggerated for clarity and convenience of description. In addition, terms to be described below are the terms defined in consideration of functions in the present invention, which may be changed according to a user's or operator's intention or custom. Therefore, the definition of these terms should be made based on the contents throughout the specification.

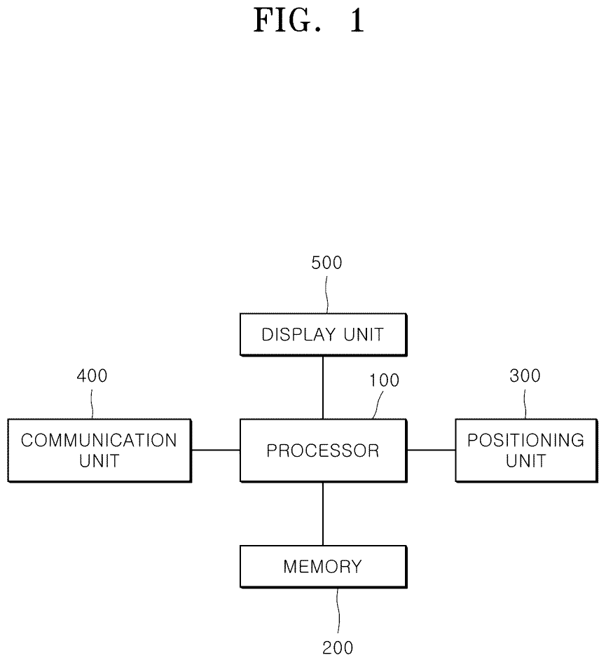

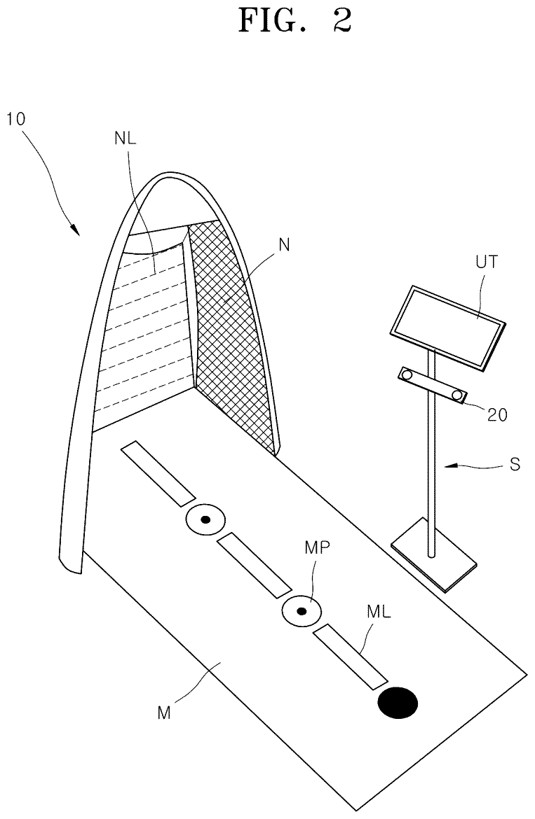

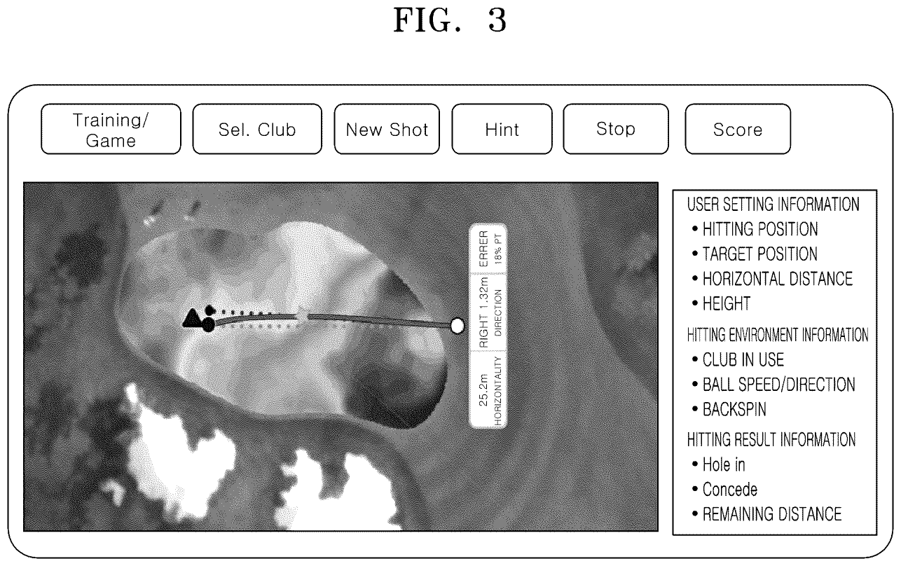

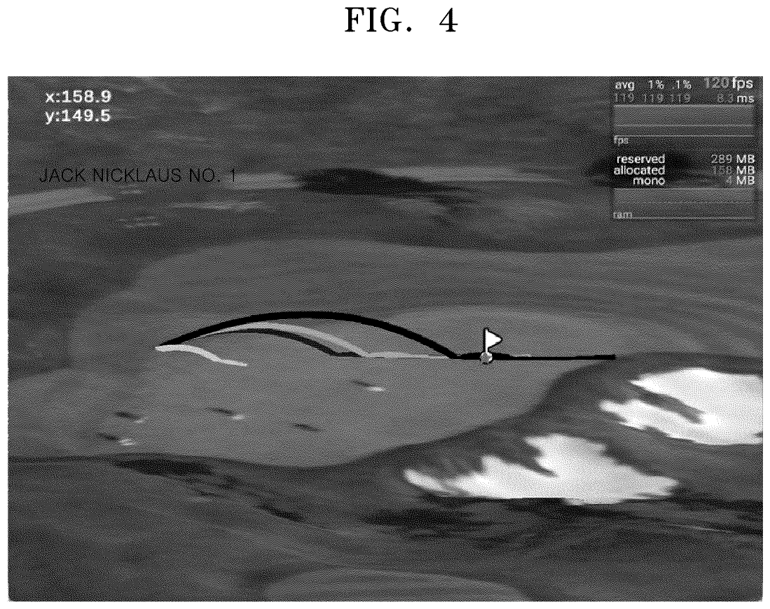

FIGS. 1 and 2 are exemplary views showing an apparatus for supporting virtual golf according to the present embodiment, and FIGS. 3 and 4 are exemplary views showing a user interface (UI) displayed through a user terminal in the apparatus for supporting virtual golf according to the present embodiment.

First, referring to FIG. 1, the apparatus for supporting virtual golf according to the present embodiment may include a processor 100, a memory 200, a positioning unit 300, a communication unit 400, and a display unit 500. Each of the components 100 to 500 may be implemented as a computing device of a user, and the computing device may be implemented as a user terminal UT (a portable device such as a smartphone or tablet, or a dedicated terminal separately provided to provide a virtual golf support service of the present embodiment) of the user. A dedicated application (hereinafter referred to as “application”) for providing the virtual golf support service of the present embodiment may be installed on the computing device, and thus the positioning unit 300, the communication unit 400, and the display unit 500 may be installed on the user terminal UT of the user, and the processor 100 and the memory 200 may be provided with an embodiment that is implemented in the form of a service server for supporting a function of the dedicated application.

The processor 100, which is a core device for providing a service for supporting virtual golf, may be implemented as a central processing unit (CPU) or system on chip (SOC), may control a plurality of hardware or software components connected to the processor 130 by driving an operating system or application, and perform various types of data processing and calculations. The processor 100 may be configured to execute at least one command stored in the memory 200 and store execution result data in the memory.

The positioning unit 300 may correspond to a Global Positioning System (GPS) positioning module mounted on the user terminal UT, and the communication unit 400 may serve as a wireless communication module (e.g., a long-term evolution (LTE) or WiFi communication module) mounted on the user terminal UT to support wireless communication between the user terminal UT and an external system (e.g., an image acquisition module 20 to be described below). The display unit 500 may be implemented as a display panel of the user terminal UT, such as a touch screen panel, and a moving trajectory of a golf ball determined by the processor 100 may be displayed through the display unit 500 and provided to the user.

At least one command executed through the processor 100 and providing the virtual golf support service based on interfacing of the user with the computing device of the present embodiment may be stored in the memory 200. The memory 200 may be implemented as a volatile storage medium and/or a non-volatile storage medium and implemented as, for example, a read only memory (ROM) and/or a random access memory (RAM).

The at least one command stored in the memory 200 and executed by the processor 100 may include the following commands.
i) A command to set a virtual play environment of virtual golf.
ii) A command to set a hitting position at which a golf ball is hit and a target position at which the golf ball reaches in the virtual play environment.
iii) A command to determine an initial speed and moving direction of the golf ball based on a golf ball image acquired at a time point when the golf ball is hit on a golf environment simulation device 10.
iv) A command to determine a moving trajectory of the golf ball by applying the hitting position, and the initial speed and moving direction to a predefined moving trajectory model.
v) A command to display the determined moving trajectory.

Based on the above, an operation of the apparatus for supporting virtual golf according to the present embodiment will be described in detail below with reference to FIG. 2.

### 1. Apparatus for Supporting Virtual Golf

Referring to FIG. 2, the apparatus for supporting virtual golf according to the present embodiment may include the golf environment simulation device 10, the image acquisition module 20, and the processor 100.

The golf environment simulation device 10 may be implemented so that hitting a golf ball and moving the golf ball according to the hitting are physically possible. Specifically, the present embodiment focuses on a short game and a putting game of golf, and the golf environment simulation device 10 may be physically installed in a space in which a user is located with a size that supports the user's short game and putting game. As shown in FIG. 2, the golf environment simulation device 10 may include a mat M on which a golf ball moves, and a net N that restricts the movement of a hit golf ball (i.e., prevents the golf ball from flying far away). A side wall (not shown) for preventing the golf ball from flying out of the mat may be provided at left and right edges of the mat M. In addition, a target point MP located at a predefined point in a middle line for a tee box point T, the middle line ML, and left and right brakes may be marked on the mat M, and an auxiliary line NL representing a flying height of a golf ball may be marked on the net N. As described above, the golf environment simulation device 10 may have a size that supports the user's short game and putting game. For example, the mat M may have a length of 2 m and a width of 70 cm, the net N may have a width of 1 m and a height of 1 m, and the side wall may have a height of 2 mm.

The image acquisition module 20 may acquire an image of the golf ball, transmit the image to the processor 100 to be described below through wired or wireless communication, and may be installed in a space in which the user is located within a range in which the image of the golf ball may be acquired. The image acquisition module 20 may include a stereo camera to acquire three-dimensional position coordinates (world coordinates) of the golf ball. The three-dimensional position coordinates of the golf ball acquired by the image acquisition module 20 may be used to calculate an initial speed of the golf ball by the processor 100 to be described below. In addition, two cameras included in the stereo camera may be calibrated in advance using the tee box point or target point on the mat as a feature point.

The image acquisition module 20 may be provided at a predefined height in a state of being held on a stand S to capture the image of the golf ball, or a structure in which the user terminal UT is held on the stand S together with the image acquisition module 20 may be adopted. The moving trajectory of the golf ball determined by the processor 100 to be described below and the result of the user's hitting (shot) may be basically displayed through the display unit 500 of the user terminal UT held on the stand S and provided to the user, and the result of hitting may be provided to the user as a voice through a speaker provided in the user terminal UT. A screen displayed on the user terminal UT may be displayed on a TV or PC provided in the space in which the user is located through a mirroring function.

As described above, the processor 100 may correspond to a subject that provides the virtual golf support service and may be implemented in a manner of being installed on the user terminal UT or installed on the service server. When the processor 100 is included in the service server, in the present embodiment, the processor 100 of the service server may be implemented in a communication type manner that supports a function of the application installed in the user terminal UT.

The processor 100 according to the present embodiment may determine an initial speed of the golf ball based on the golf ball image acquired by the image acquisition module 20 at the time point when the golf ball is hit on the golf environment simulation device 10, determine the moving trajectory of the golf ball based on the hitting position at which the golf ball is hit and the determined initial speed in the virtual play environment for the user's virtual golf, and display the determined moving trajectory through the display unit 500. The operation of the processor 100 will be described in more detail as follows.

First, the processor 100 creates the user's account according to the user's manipulation (e.g., touch) for the application installed on the user terminal UT (account creating operation). The moving trajectory and hitting result (e.g., hole in, concede, or the remaining distance) of the golf ball, which will be described below, are stored separately for each user's account.

Subsequently, the processor 100 sets the virtual play environment (e.g., a specific field (golf course) for proceeding with virtual golf) for the user's virtual golf according to the user's manipulation of the application (environment setting operation). The virtual play environment includes information about the field and actual terrain data of the field. The terrain data may correspond to three-dimensional (3D) terrain data (3D terrain map) having a three-axis coordinate system in which an altitude acquired by a LiDAR positioning method is reflected in a two-dimensional (2D) orthophoto. The terrain data may be stored in advance in the memory 200 after the terrain (position and altitude) of the field is measured by a LiDAR sensor mounted on an aircraft such as a drone, and thus the terrain data may correspond to 3D positioning data having a three-axis coordinate system.

Subsequently, the processor 100 sets a club used for hitting the golf ball according to the user's manipulation for the application (club setting operation). When the club is selected as a putter, the processor 100 considers hitting as putting (in this case, only a rolling trajectory is determined in the process of determining the moving trajectory of the golf ball to be described below, which will be described below), and when another club (e.g., a wedge) is selected, hitting is considered as approaching. When there is no user's separate manipulation (default), hitting is considered as putting.

Subsequently, the processor 100 sets a hitting position at which the golf ball is hit and a target position at which the golf ball reaches in the virtual play environment according to the user's manipulation for the application (position setting operation). That is, the hitting position and the target position may be set by the user's touching a specific point in a state in which the virtual play environment (terrain data) is displayed through the user terminal UT. Since the virtual play environment, i.e., the terrain data, corresponds to the 3D positioning data having the three-axis coordinate system, the hitting position and the target position are also formed of 3D position coordinates.

Subsequently, the processor 100 recognizes the golf ball based on the golf ball image acquired by the image acquisition module 20 at the time point when the golf ball is hit by the user on the golf environment simulation device 10 (golf ball recognizing operation). As described above, the processor 100 may identify the 3D position coordinates of the golf ball acquired by the image acquisition module 20 (i.e., stereo camera) and determine the initial speed of the golf ball in a manner of differentiating a change in acquired 3D position coordinates over time. Hereinafter, the initial speed of the golf ball is described as including three-axis direction information as a concept of a vector.

In this case, the processor 100 may recognize the golf ball in a manner of applying a known image processing algorithm to a stereo camera image and recognize the golf ball in a manner of applying pixel information about the stereo camera image to a deep learning model that is a pre-learned artificial intelligence model. When recognizing the golf ball through the deep learning model, the processor 100 may recognize the golf ball at a more accurate level. In particular, when a convolutional neural network is used, the golf ball may be accurately recognized in real time without much calculation. In this case, the initial speed and moving direction of the golf ball may be determined in a manner of analyzing an afterimage of the stereo camera image and comparing a pixel position of the golf ball in a stationary state with a pixel position of the golf ball moving for a predefined time.

Subsequently, the processor 100 applies the hitting position and initial speed determined through the above process to a predefined moving trajectory model to determine the moving trajectory of the golf ball (trajectory determining operation). The moving trajectory of the golf ball may include a flight trajectory, a bounce trajectory, and a rolling trajectory, and thus the process of determining the moving trajectory of the golf ball may be largely classified into a process of determining the flight trajectory, a process of determining the bounce trajectory, and a process of determining the rolling trajectory. Detailed description of the process of determining the moving trajectory of the golf ball will be described separately below.

Subsequently, the processor 100 superimposes the determined moving trajectory on the virtual play environment and displays the same through the display unit 500 of the user terminal UT (displaying operation) (FIGS. 3 and 4 show examples of UI including the moving trajectory of the golf ball displayed through the user terminal UT) (FIG. 4 shows a plurality of golf ball moving trajectories to help understand the embodiment). Together with the moving trajectory of the golf ball, user setting information (hitting position and target position, horizontal distance and height between the hitting position and the target position, etc.), hitting environment information (club used, initial speed and moving direction of the golf ball, backspin, etc.), and hitting result information (hole in, concede, remaining distance, etc.) may also be displayed together.

When the user's hitting result does not correspond to “hole-out” or “concede” (i.e., the golf ball does not reach the target position), the processor 100 performs an additional operation for allowing the user to continuously play the virtual golf in the case of no separate manipulation of the user for the application, such as clicking a “Stop” button for ending the virtual golf or clicking a “New Shot” button for a new hit on the UI provided through the application. Specifically, the processor 100 resets a final point of the moving trajectory of the golf ball to a new hitting position in the virtual play environment (position resetting operation) and then re-performs the above-described speed determining operation, trajectory determining operation, and displaying operation.

When the above-described position resetting operation and the golf ball recognizing operation, speed determining operation, trajectory determining operation, and displaying operation that are performed after the position resetting operation are defined as one operation cycle, the processor 100 repeatedly performs the above-described operation cycle until the golf ball reaches the target position in the case of no separate manipulation of the user for the application, such as clicking the “Stop” button for ending the virtual golf on the UI or clicking the “New Shot” button for the new hit. Therefore, in the case of no separate manipulation of the user, the user may continue playing virtual golf until a hole in or concede occurs, and a distance difference between the final point of the moving trajectory and the target position (i.e., the remaining distance) is provided to the user through the application every time one operation cycle is ended (i.e., for each hit by the user) until the golf ball reaches the target position. In addition, the user's score is continuously updated and stored in the virtual golf process, and a current score may be provided when the “Score” button on the UI is clicked.

When the user clicks the “Hint” button on the UI provided through the application, the processor 100 may calculate the initial speed of the golf ball required to reach the target position from the currently set hitting position and then provide the calculated initial speed to the user through the application. In this process, the initial speed of the golf ball provided to the user serves as “correct data” for reaching the target position, and the user may hit the golf ball by referring to the initial speed as the correct data provided through the application. As described above, since the initial speed is a vector, “speed” and “direction” are provided to the user together. The initial speed may be calculated based on the above-described moving trajectory model. That is, as described below, the moving trajectory model operates to calculate the moving trajectory of the golf ball by inputting the hitting position and initial speed of the golf ball, and thus the processor 100 may calculate the initial speed of the golf ball required to reach the target position in a manner of setting the final point of the moving trajectory of the golf ball to the target position and reversely inputting the final point together with the hitting position of the golf ball into the moving trajectory model to reversely calculate the initial speed of the golf ball.

Meanwhile, the processor 100 may support a training mode in which one user practices golf and a game mode in which multiple users play a virtual golf game through an application, and the above-described operation of the processor 100 is commonly applied to the training mode and the game mode.

The game mode corresponds to a mode in which multiple users located at remote positions play the virtual golf game based on the golf environment simulation device 10 and the image acquisition module 20 provided at a position of each user. That is, the multiple users may create user accounts through applications on their own user terminals UT and access a service server to play a virtual golf game online. The processor 100 (e.g., a processor of the service server) may record scores, which are calculated as the multiple users play the virtual golf game, for each of the multiple users and provide the scores through the application.

### 2. Method of Supporting Virtual Golf

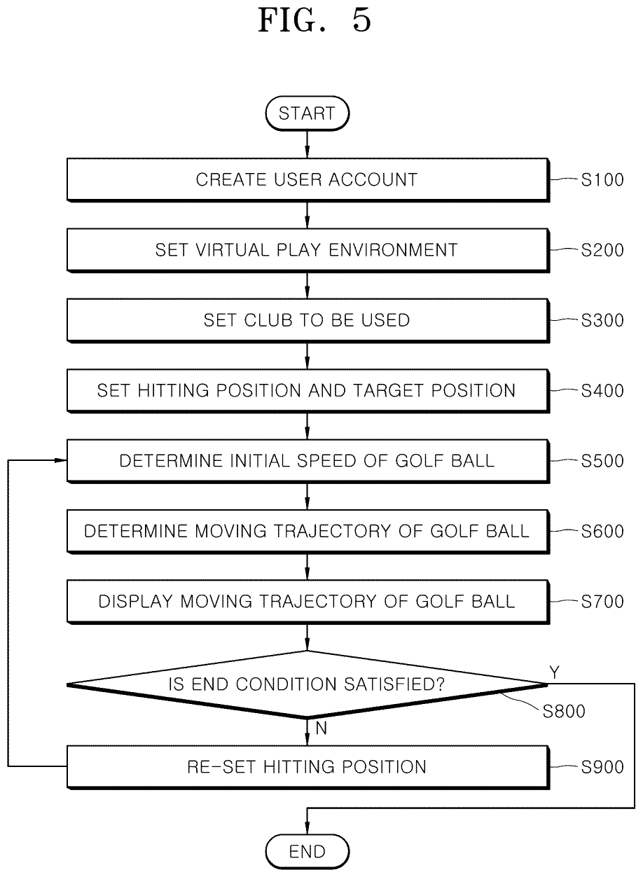

FIG. 5 is a flowchart showing a method of supporting virtual golf according to the present embodiment. Referring to FIG. 5, the method of supporting virtual golf according to the present embodiment will be described, detailed descriptions of parts overlapping the above-described contents will be omitted, and descriptions of the time-series configuration will be made.

First, the processor 100 creates a user's account according to the user's manipulation for the application installed on the user terminal UT (S100).

Subsequently, the processor 100 sets a virtual play environment for the user's virtual golf according to the user's manipulation for the application (S200), sets a club used for hitting a golf ball (S300), and sets a hitting position at which the golf ball is hit and a target position at which the golf ball reaches in the virtual play environment (S400). The performance order of operations S200 to S400 may be changed.

Subsequently, the processor 100 determines the initial speed of the golf ball based on the golf ball image acquired by the image acquisition module 20 at the time point when the golf ball is hit by the user on the golf environment simulation device 10 (S500).

Subsequently, the processor 100 applies the hitting position and initial speed determined in each of the operations S400 and S500 to a predefined moving trajectory model to determine a moving trajectory of the golf ball (S600). Detailed description of the process of determining the moving trajectory of the golf ball will be described separately below.

Subsequently, the processor 100 superimposes the moving trajectory determined in operation S600 on a virtual play environment and displays the same through the display unit 500 of the user terminal UT (S700).

As a case in which the user's hitting result does not correspond to “hole-out” or “concede” (i.e., the golf ball does not reach the target position), in the case of no separate manipulation of the user for the application, such as clicking a “Stop” button for ending the virtual golf or clicking a “New Shot” button for a new hit on the UI provided through the application (S800), the processor 100 re-sets the final point of the golf ball moving trajectory to a new hitting position in the virtual play environment (S900) and then re-performs operations S500, S600, and S700.

When operation S900 and operations S500, S600, and S700 performed after operation S900 are defined as one operation cycle, the operation cycle is repeatedly performed until end conditions in operation S800 are satisfied.

When the user clicks the “Hint” button on the UI provided through the application in the process of performing operations S400 to S900, the processor 100 may calculate the initial speed of the golf ball required to reach the target position from the currently set hitting position and then provide the calculated initial speed to the user through the application. In addition, the operations of operations S100 to S900 are commonly applied to the training mode and game mode supported through the application.

### 3. Method of Determining Moving Trajectory of Golf Ball

Before specifically describing the process of determining a moving trajectory of a golf ball, first, a mesh model that is the basis of the present embodiment will be described.

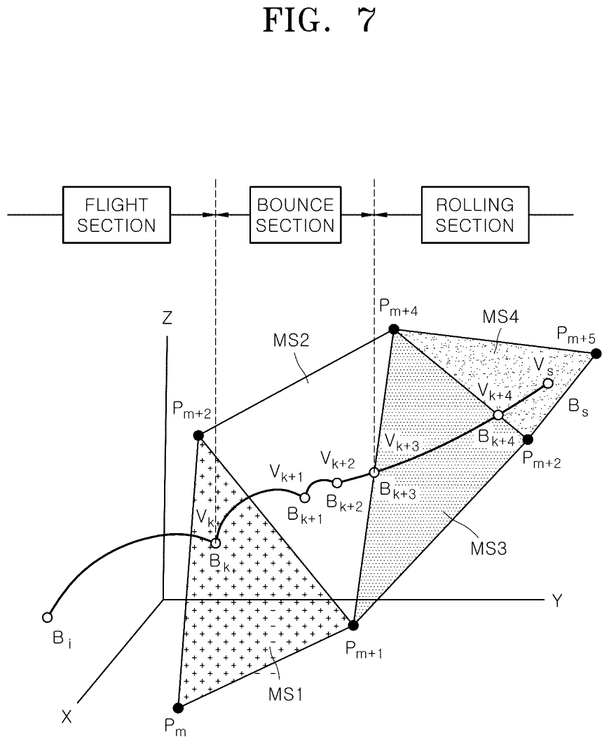

As shown in FIG. 7, the mesh model is defined as a model in which the terrain data of the field (i.e., a golf course (golf course terrain)) that becomes a moving space of the golf ball is emulated as first to N^{th} plane meshes (N is a natural number of 2 or more, and FIG. 7 shows an example in which the mesh model is composed of first to fourth plane meshes MS1 to MS4 as N is assumed to be 4).

Each plane mesh is formed of a triangular planar structure, and metadata (including physical property data such as a slope and coefficient of restitution of the plane mesh, mathematical attribute data such as vertex coordinate data Pₘ, . . . , and Pₖ, normal vector n, and flow vector p of each plane mesh, and regulation data such as fairway, green, hazard, and out of bound (OB) according to the corresponding golf course rules) for each plane mesh may be defined in the mesh model. Thus, a plurality of plane meshes (i.e., the first to N^{th} plane meshes) are arranged consecutively with a slope defined according to the above metadata, and thus the mesh model is configured so that the field is emulated as a 3D space defined by a three-axis coordinate system (x-axis, y-axis, and z-axis). FIG. 7 shows an example in which a golf ball is hit at a hitting position Bᵢ, lands at point Bₖ of the first plane mesh MS1, bounces at points Bₖ and Bₖ₊₁ by a repulsive force to perform a subsequent flight (bounce), starts to roll from point Bₖ₊₂ of the second plane mesh MS2 to enter the fourth plane mesh MS4 through point Bₖ₊₃ on a boundary line “Pₘ₊₁−Pₘ₊₄” and point Bₖ₊₄ on a boundary line “Pₘ₊₂−Pₘ₊₄,” and then stops at point Bₛ.

The mesh model configured as described above becomes the basis for mathematically defining the flight trajectory model, bounce trajectory model, and cloud trajectory model used to derive the flight trajectory, bounce trajectory, and rolling trajectory of the golf ball, as will be described below. The process to be described below assumes that the processor 100 receives the mesh model defined as described above from an external system through the communication unit 400 and stores the mesh model in the memory 200.

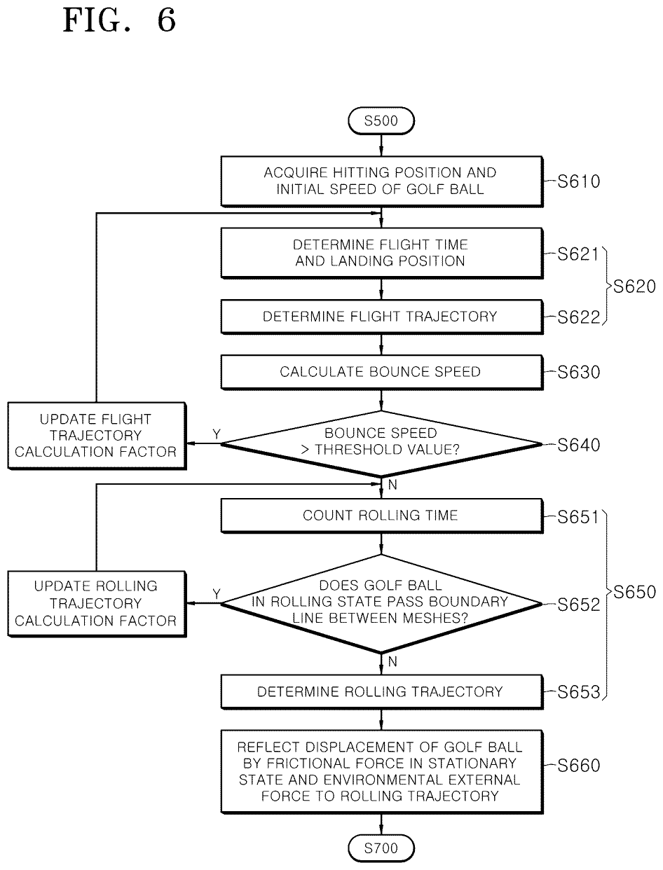

Based on the above-described contents, the process of determining a trajectory of a golf ball will be described in detail below with reference to FIGS. 6 to 8, and the following description will be made based on each operation of the “2. Method of supporting virtual golf” to specify the time-series configuration.

Referring to FIG. 6, first, the processor 100 identifies the hitting position of the golf ball set in operation S400 and the initial speed of the golf ball determined in operation S500 (S610). The hitting position and initial speed of the golf ball have three-axis components based on the three-axis coordinate system.

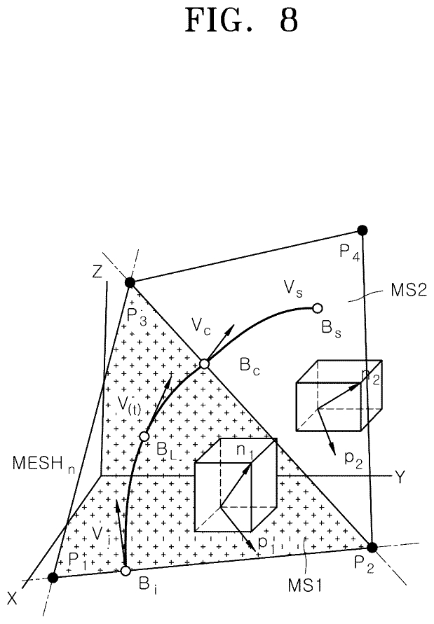

When the hitting position and initial speed of the golf ball are specified through operation S610, the processor 100 applies the hitting position and initial speed of the golf ball as flight trajectory calculation factors to a predefined flight trajectory model to determine the flight trajectory from the time the golf ball starts to fly due to hitting power to the time the golf ball lands in the M^{th} plane mesh included in the mesh model (S620). The plane mesh on which the golf ball initially lands (i.e., the plane mesh corresponding to the target position set in operation S400) is marked by an M^{th} plane mesh (M is a natural number smaller than or equal to N), and FIGS. 7 and 8 show examples in which the M^{th} plane mesh is the first plane mesh MS1.

External forces such as gravity, an air frictional force, and a wind force and internal forces due to the golf ball's own spin act on the golf ball in flight, and in the present embodiment, only gravity is considered as a force acting on the golf ball in flight to reduce a computational load. Therefore, the acceleration acting on the golf ball in flight is represented by Expression 1 below.

$${a}_{x} = 0 , {a}_{y} = 0 , {a}_{z} = - g \qquad [ Expression 1 ]$$

In Expression 1, aₓ, a_{y}, and a_{z} denote accelerations in x-axis, y-axis, and z-axis directions, respectively, and g denotes the acceleration of gravity.

The flight trajectory model applied in operation S620 is defined as in Expression 2 below by a uniformly accelerated motion expression.

$$v ( t ) = {V}_{i} + a \cdot t \qquad [ Expression 2 ]$$

$$B ( t ) = {B}_{i} + {V}_{i} \cdot t + a \cdot {t}^{2} / 2$$

In Expression 2, v(t) denotes a speed of the golf ball t time after the start of flight, Vᵢ denotes an initial speed of the golf ball, a denotes an acceleration acting on the golf ball, B(t) denotes a position of the golf ball after t time, and Bᵢ denotes the hitting position of the golf ball. v(t), Vᵢ, a, B(t), and Bᵢ have three-axis components according to the three-axis coordinate system.

Meanwhile, when a normal vector of the M^{th} plane mesh on which the golf ball first lands is n(nₓ, n_{y}, n_{z})=n(cosα, cosβ, cosθ) (here, α, β, and θ denote angles formed by the normal vectors with the x-axis, y-axis, and z-axis, respectively, and n denotes a vector notation) and coordinates of one vertex of the M^{th} plane mesh are defined as (Xₘ, Yₘ, Zₘ), the expression of the plane as a mathematical model defining the M^{th} plane mesh is represented by Expression 3 below.

$${n}_{x} ( x - {X}_{m} ) + {n}_{y} ( y - {Y}_{m} ) + {n}_{z} ( z - {Z}_{m} ) = 0 \qquad [ Expression 3 ]$$

In Expression 3, the variables x, y, and z denote the coordinates of points on the M^{th} plane mesh.

Therefore, the processor 100 may determine a flight time and landing position from the time the golf ball starts to fly to the time the golf ball lands in the M^{th} plane mesh from the mathematical model defining the M^{th} plane mesh (Expression 3) and the flight trajectory model (Expression 2) (S621).

Specifically, when the hitting position of the golf ball is Bᵢ=(xᵢ, yᵢ, zᵢ), the flight time is T_{L}, and the landing position of the golf ball is B_{L}=(x_{L}, y_{L}, z_{L}), the landing position of the golf ball is represented by Expression 4 below according to Expressions 1 and 2.

$${x}_{L} = {x}_{i} + {V}_{ix} \cdot {T}_{L} \qquad [ Expression 4 ]$$

$${y}_{L} = {y}_{i} + {V}_{iy} \cdot {T}_{L}$$

$${z}_{L} = {z}_{i} + {V}_{iz} \cdot {T}_{L} - g \cdot {T}_{L}^{2} / 2$$

In Expression 4, Vᵢₓ, V_{iy}, and V_{iz} denote x-axis, y-axis, and z-axis components of the initial speed of the golf ball.

Since the landing position of the golf ball is present on the M^{th} plane mesh according to Expression 3, Expression 5 below is derived.

$${n}_{x} ( {x}_{L} - {X}_{m} ) + {n}_{y} ( {y}_{L} - {Y}_{m} ) + {n}_{z} ( {z}_{L} - {Z}_{m} ) = 0 \qquad [ Expression 5 ]$$

By combining Expressions 4 and 5, the flight time T_{L} of the golf ball is derived as in Expression 6 below.

$${T}_{L} = - {c}_{1} \pm \sqrt{( {c}_{1}^{2} - 2 {c}_{2} )} \qquad [ Expression 6 ]$$

$$where$$

$${c}_{1} = ( {n}_{x} \cdot {V}_{ix} + {n}_{y} \cdot {V}_{iy} + {n}_{z} \cdot {V}_{iz} ) / ( - g \cdot {n}_{z} )$$

$${c}_{2} = ( {n}_{x} \cdot ( {x}_{i} - {X}_{m} ) + {n}_{y} \cdot ( {y}_{i} - {Y}_{m} ) + {n}_{z} \cdot ( {z}_{i} - {Z}_{m} ) ) / ( - g \cdot {n}_{z} )$$

As the flight time T_{L} is determined, the landing speed and landing position of the golf ball according to Expression 4 may also be determined, and the landing speed V_{L} and the landing position B_{L} are derived as in Expression 7 below.

$${V}_{L} = {V}_{i} + a \cdot {T}_{L} \qquad [ Expression 7 ]$$

$${B}_{L} = {B}_{i} + {V}_{i} \cdot {T}_{L} + a \cdot {T}_{L}^{2} / 2$$

$$( {B}_{Lx} = {x}_{L} = {x}_{i} + {V}_{ix} \cdot {T}_{L} )$$

$$( {B}_{Ly} = {y}_{L} = {y}_{i} + {V}_{iy} \cdot {T}_{L} )$$

$$( {B}_{Lz} = {z}_{L} = {z}_{i} + {V}_{iz} \cdot {T}_{L} - g \cdot {T}_{L}^{2} / 2 )$$

Through the above process, the processor 100 may determine that a path connecting the hitting position of the golf ball, a flight section determined by the flight trajectory model during the flight time, and the landing position of the golf ball is a flight trajectory (S622).

Then, the processor 100 applies the landing position and bounce speed of the golf ball on the M^{th} plane mesh as the bounce trajectory factors to the bounce trajectory model to determine the bounce trajectory formed by the golf ball landed on the M^{th} plane mesh and then bouncing therefrom.

Specifically, after operation S620, the processor 100 calculates the bounce speed of the golf ball from the landing speed of the golf ball on the M^{th} plane mesh and the coefficient of restitution defined in advance for the M^{th} plane mesh (S630). When the coefficient of restitution of the M^{th} plane mesh is defined as e (e.g., 0.6), Expression 8 below is derived according to a speed relationship expression before and after collision.

$$R ( {T}_{L} ) = {V}_{L} - ( 1 + e ) \cdot {V}_{L} \cdot n \qquad [ Expression 8 ]$$

In Expression 8, R(T_{L}) denotes the bounce speed.

Subsequently, the processor 100 compares the bounce speed of the golf ball calculated by Expression 8 with a preset threshold value R_{c} (S640). The threshold value may be stored in advance in the memory 200 as a specific value based on a designer's intention and experimental results as a reference value for determining whether the golf ball will re-fly or roll due to the bounce after the golf ball lands (e.g., 1.0 mm/s).

When it is determined that the bounce speed of the golf ball is the threshold value or more in operation S640, the processor 100 determines the bounce trajectory in a manner of applying the landing position and bounce speed of the golf ball as flight trajectory calculation factors and then repeatedly performing operation S620. That is, in operation S620 performed first, the hitting position and initial speed of the golf ball are used as the flight trajectory calculation factors, and when the bounce speed after the golf ball lands is the threshold value or more and the golf ball re-starts to fly, the processor 100 determines the bounce trajectory in a manner of updating the flight trajectory calculation factors for determining the flight trajectory to the landing position and bounce speed of the golf ball derived according to Expression 7 and then repeatedly performing operation S620 of determining the flight trajectory. The above process is repeatedly performed until the bounce speed of the golf ball becomes smaller than the threshold value.

When it is determined that the bounce speed of the golf ball is smaller than the threshold value in operation S640 (including the case in which it is determined that the bounce speed of the golf ball is smaller than the threshold value after operation S620 is repeatedly performed), the processor 100 applies the rolling start position and rolling start speed of the golf ball on a K^{th} plane mesh, and an external force acting on the golf ball as rolling trajectory calculation factors to a predefined rolling trajectory model to determine a rolling trajectory in which the golf ball rotates and moves on the K^{th} plane mesh (S650). K is a natural number that is M or more and smaller than or equal to N, that is, when the golf ball that lands on the M^{th} plane mesh starts to roll, the K^{th} plane mesh is the same as the M^{th} plane mesh, and when the golf ball repeats multiple flights and moves to an adjacent plane mesh, the K^{th} plane mesh may correspond to any one of K+1^{th} to N^{th} plane meshes. Hereinafter, operation S650 will be described assuming a case in which the K^{th} plane mesh is the same as the M^{th} plane mesh.

In operation S650, the processor 100 determines a rolling trajectory using a flow line vector defined by a normal vector and slope of the K^{th} plane mesh as parameters. As known, a flow line is a line along which an object on a plane is moved by vertical gravity and a slope of the plane, and a flow line vector of a K^{th} plane is defined as p(pₓ, p_{y}, p_{z})=p(nₓ·n_{z}/sinθ, n_{y}·n_{z}/sinθ, −sinθ) by the normal vector and slope of the K^{th} plane mesh.

As the rolling trajectory calculation factor, an external force acting on the golf ball may include gravity and frictional force acting on the golf ball on the K^{th} plane mesh. Since the golf ball rolls on the K^{th} plane mesh having a predefined slope, the gravitational acceleration acting on the golf ball should be corrected by the above-described flow line vector, and thus considering the corrected gravitational acceleration and a frictional deceleration acting on the golf ball by a friction coefficient of the K^{th} plane mesh, the acceleration acting on the rolling golf ball is represented by Expression 9 below.

$$a = {g}_{p} \cdot p + μ \cdot {n}_{z} \cdot u \qquad [ Expression 9 ]$$

In Expression 9, gₚ denotes the corrected gravitational acceleration (g·sinθ), μ denotes the frictional deceleration of the K^{th} plane mesh (m/s²), and u denotes a unit vector of a rolling start speed.

The rolling trajectory model applied in operation S650 is defined as in Expression 10 below by the uniformly accelerated motion expression.

$$\begin{matrix}v ( t ) = {V}_{i} + a \cdot t \\ B ( t ) = {B}_{i} + {V}_{i} \cdot t + a \cdot {t}^{2} / 2\end{matrix} \qquad [ Expression 10 ]$$

In Expression 10, v(t) denotes a speed of the golf ball t time after the start of rolling, Vᵢ denotes a rolling start speed, a denotes an acceleration acting on the golf ball, B(t) denotes a position of the golf ball after t time, and Bᵢ denotes a rolling start position. v(t), Vᵢ, a, B(t), and Bᵢ have three-axis components according to the three-axis coordinate system (for convenience, they are denoted by the same notation as Expressions 1 to 7 for calculating the flight trajectory of the golf ball, but it should be noted that factors of Expressions 1 to 7 according to operation S620 and factors of Expressions 9 to 17 according to operations S650 and S660 are clearly distinguished).

In operation S650, the processor 100 counts a rolling time that has elapsed after the golf ball starts to roll (S651) and determines the rolling trajectory in a manner of reflecting a rolling section (i.e., B(t) in Expression 10) determined by the rolling trajectory model for the counted rolling time (S652 and S653).

Meanwhile, there may occur a case in which the golf ball moves from the K^{th} plane mesh to the K+1^{th} plane mesh through the rolling movement, and in this case, the processor 100 may perform a continuous rolling trajectory determining operation. The continuous rolling trajectory determining operation is defined by the following processes.
i) A process of determining, from the mathematical model and the rolling trajectory model that define the boundary line of the K^{th} plane mesh and the K+1^{th} plane mesh, the time (referred to a passing time) required from the rolling start position of the golf ball on the K^{th} plane mesh to reaching the boundary line.
ii) A process of determining the rolling start position and rolling start speed of the golf ball on the K+1^{th} plane mesh using the passing time and the normal vector of the K+1^{th} plane mesh.
iii) A process of determining the rolling trajectory of the golf ball on the K+1^{th} plane mesh using the determined rolling start position and rolling start speed of the golf ball on the K+1^{th} plane mesh and the gravity and frictional force acting on the golf ball on the K+1^{th} plane mesh as the rolling trajectory calculation factors.

Specifically describing each process, when coordinates of both ends of the boundary line of the K^{th} plane mesh and the K+1^{th} plane mesh are defined as P₂(X2, Y2, Z2) and P₃(X3, Y3, Z3), respectively, the boundary line is defined by Expression 11 below (see FIG. 8).

$$\frac{( {x}_{c} - X 2 )}{X 32} - \frac{( {y}_{c} - Y 2 )}{Y 32} = 0 \qquad [ Expression 11 ]$$

$$where$$

$$X 32 = X 3 - X 2 , Y 32 = Y 3 - Y 2$$

In Expression 11, x_{c} and y_{c} denote an x-coordinate and y-coordinate of a point at which the golf ball passes the boundary line (hereinafter, the passing point).

When the passing time from the rolling start position to the passing point of the golf ball is T_{c}, the passing point is represented by Expression 12 below using Expression 10.

$${B}_{c} = {B}_{i} + {V}_{i} \cdot t + a \cdot {T}_{c}^{2} / 2 \qquad [ Expression 12 ]$$

$$where$$

$$a = {g}_{p} \cdot p + μ \cdot {n}_{z} \cdot u$$

When Expressions 11 and 12 are combined, the passing time T_{c} from the rolling start position to the passing point of the golf ball is derived as in Expression 13 below.

$${T}_{c} = - {c}_{1} \pm \sqrt{( {c}_{1}^{2} - 2 {c}_{2} )} \qquad [ Expression 13 ]$$

$$where$$

$${c}_{1} = ( {V}_{ix} \cdot Y 32 - {V}_{iy} \cdot X 32 ) / ( {a}_{x} \cdot Y 32 - {a}_{y} \cdot X 32 )$$

$${c}_{2} = \{ ( {x}_{i} - X 2 ) \cdot Y 32 - ( {y}_{i} - Y 2 ) \cdot X 32 \} / ( {a}_{x} \cdot Y 32 - {a}_{y} \cdot X 32 )$$

$${a}_{x} = - ( g \cdot {n}_{x} + μ \cdot {V}_{ix} / \vert {V}_{i} \vert ) \cdot {n}_{z}$$

$${a}_{y} = - ( g \cdot {n}_{y} + μ \cdot {V}_{iy} / \vert {V}_{i} \vert ) \cdot {n}_{z}$$

$${a}_{z} = - ( g \cdot ( {n}_{z}^{2} - 1 ) + μ \cdot {n}_{z} \cdot {V}_{iz} / \vert {V}_{i} \vert )$$

When the passing time T_{c} until the golf ball reaches the passing point is determined through the above process, the processor 100 determines the rolling start position and rolling start speed of the golf ball on the K+1^{th} plane mesh using the determined passing time and the normal vector of the K+1^{th} plane mesh. Since the rolling start position corresponds to the passing point, the processor 100 determines the rolling start speed, but in this case, when the golf ball moves from the K^{th} plane mesh to the K+1^{th} plane mesh, the slope is changed and the normal vector of each plane mesh is also changed accordingly, and thus the processor 100 determines the rolling start speed of the golf ball using the normal vector of the K+1^{th} plane mesh (i.e., determines the rolling start speed of the golf ball on the K+1^{th} plane mesh in a manner of correcting the speed of the golf ball at T_{c} calculated based on the K^{th} plane mesh using the normal vector of the K+1^{th} plane mesh).

When the speed of the golf ball at T_{c} calculated based on the K^{th} plane mesh is Vᵢ(V_{cx}, V_{cy}, V_{cz}) (which may be derived by applying T_{c} to v(t) of Expression 10), the rolling start speed on the K+1^{th} plane mesh may be represented by Expression 14 below.

$${{V}_{i}}^{′} ( {V}_{c x} , {V}_{cy} , - ( {V}_{c x} \cdot {{n}_{x}}^{′} + {V}_{c y} \cdot {{n}_{y}}^{′} ) / {{n}_{z}}^{′} ) \qquad [ Expression 14 ]$$

In Expression 14, nₓ′, n_{y}′, and n_{z}′ denote normal vector components of the K+1^{th} plane mesh.

The processor 100 determines the rolling trajectory of the golf ball on the K+1^{th} plane mesh using the determined rolling start position and rolling start speed of the golf ball at the K+1^{th} plane mesh and the gravity and frictional force acting on the golf ball on the K+1^{th} plane mesh as the rolling trajectory calculation factors. The continuous rolling trajectory determining operation according to Expressions 11 to 14 is repeatedly performed until the golf ball stops.

Next, describing a process of calculating the stop position of the golf ball (assuming that the golf ball stops on the K^{th} plane mesh), when the time (represented by the stop time) required for the golf ball to stop after starting to roll is Tₛ, Expression 15 below is derived according to Expressions 9 and 10.

$$v ( {T}_{s} ) = {V}_{i} + a \cdot {T}_{s} = {V}_{i} + {T}_{s} \cdot ( {g}_{p} \cdot p + μ \cdot {n}_{z} \cdot u ) = 0 \qquad [ Expression 15 ]$$

When components in Expression 15 are summarized individually for each axis component, the components are represented by Expression 16 below.

$$v ( {T}_{sx} ) = {V}_{ix} - {T}_{sx} \cdot ( g \cdot {n}_{x} + μ \cdot {u}_{x} ) \cdot {n}_{z} = 0 \qquad [ Expression 16 ]$$

$$v ( {T}_{sy} ) = {V}_{iy} - {T}_{sy} \cdot ( g \cdot {n}_{y} + μ \cdot {u}_{y} ) \cdot {n}_{z} = 0$$

$$v ( {T}_{sz} ) = {V}_{iz} - {T}_{sz} \cdot ( g \cdot ( 1 - {n}_{z}^{2} ) - μ \cdot {u}_{z} \cdot {n}_{z} ) = 0$$

The processor 100 determines that the maximum value among Tₛₓ, T_{sy}, and T_{sz} determined through Expression 16 is a final stop time Tₛ and applies the determined Tₛ to B(t) of Expression 10 to determine a final stop position Bₛ.

Meanwhile, once the golf ball stops, the golf ball does not normally moves any more, but when a force applied to the golf ball due to wind or ground movement is larger than a static friction force, the golf ball may move. Therefore, after operation S650, when an environmental external force (wind force or ground movement) emulated by environmental factors of the field is applied to the golf ball in a state in which the golf ball has stopped, the processor 100 may calculate the displacement of the golf ball from the frictional force and the environmental external force of the plane mesh in which the stopped golf ball is located and reflect the calculated displacement of the golf ball to the rolling trajectory (S660).

When the static friction force defined according to a static friction coefficient is F_{L} and the external force defined according to the acceleration according to Expression 9 is F, a speed and position of the golf ball formed by the environmental external force may be represented by Expression 17 below (assuming that a mass of the golf ball has a constant value of 1).

$$v ( t ) = ( F - {F}_{L} ) \cdot t \qquad [ Expression 17 ]$$

$$B ( t ) = {B}_{s} + ( F - {F}_{L} ) \cdot {t}^{2} / 2$$

The process of reflecting the displacement due to the environmental external force to the rolling trajectory may be repeatedly performed until the golf ball finally stops (e.g., in the case of the golf ball remaining in the stationary state for a predefined time section).

As described above, according to the present invention, it is possible to allow an individual to easily identify a trajectory formed by hitting a golf ball in a small space such as an individual's home while using a portable device such as an individual's mobile phone to practice golf and at the same time, allow a number of users to enjoy a virtual golf game.

The implementation described in the present specification may be implemented, for example, as a method or process, device, a software program, a data stream, or a signal. Although described only in the context of the implementation of a single form (e.g., only a method is described), the implementations of the described features may also be implemented in other forms (e.g., devices or programs). The device may be implemented with appropriate hardware, software, firmware, etc. The method may be implemented in a device such as a processor, which is generally a processing device including a computer, a microprocessor, an integrated circuit, or a programmable logic device. The processor includes a communication device such as computers, cell phones, portable/personal digital assistant (PDA), and other devices, which facilitate information communication between end-users.

According to the present invention, it is possible to allow an individual to easily check a trajectory formed by hitting a golf ball in a small space such as the individual's home while using a portable device such as the individual's mobile phone to practice golf, and at the same time, allow many users to enjoy a virtual golf game.

The present invention has been described with reference to embodiments shown in the accompanying drawings, but it is merely illustrative, and those skilled in the art to which the relevant technology pertains will understand that various modifications and other equivalent embodiments are possible therefrom. Therefore, the true technical scope of the present invention should be determined by the appended claims.

What is claimed is:

1. An apparatus for supporting virtual golf, comprising:
a golf environment simulation device implemented such that a golf ball is physically hit and moved by the hit;
an image acquisition module configured to acquire an image of the golf ball; and
a processor configured to recognize the golf ball based on the image of the golf ball acquired by the image acquisition module at a time point when the golf ball is hit on the golf environment simulation device to determine an initial speed and moving direction of the golf ball, determine a moving trajectory of the golf ball based on a hitting position at which the golf ball is hit and the determined initial speed and moving direction in a virtual play environment for the virtual golf for a user, and display the determined moving trajectory.

2. The apparatus of claim 1, wherein the processor performs:
an environment setting operation of setting the virtual play environment;
a position setting operation of setting a hitting position at which the golf ball is hit and a target position at which the golf ball reaches in the set virtual play environment;
a speed and moving direction determining operation of recognizing the golf ball through a pre-learned deep learning model based on the image of the golf ball acquired by the image acquisition module at the time point when the golf ball is hit on the golf environment simulation device to determine the initial speed and moving direction of the golf ball;
a trajectory determining operation of applying the hitting position, and the initial speed and moving direction to a predefined moving trajectory model to determine the moving trajectory of the golf ball; and
a displaying operation of superimposing and displaying the determined moving trajectory on the virtual play environment.

3. The apparatus of claim 2, wherein the processor further performs a position re-setting operation of re-setting a final point of the moving trajectory determined according to the trajectory determining operation as a new hitting position in the virtual play environment in the case of no separate manipulation of the user, and
the processor re-performs the speed and moving direction determining operation, the trajectory determining operation, and the displaying operation after performing the position re-setting operation.

4. The apparatus of claim 3, wherein, when the position re-setting operation, and the speed and moving direction determining operation, the trajectory determining operation, and the displaying operation that are performed after the position re-setting operation are defined as one operation cycle, the processor repeatedly performs the operation cycle until the golf ball reaches the target position in the case of no separate manipulation of the user.

5. The apparatus of claim 2, wherein the processor calculates the initial speed and moving direction of the golf ball required for the golf ball to reach the target position from the hitting position based on the target position set according to the position setting operation and the moving trajectory model, and then provides the calculated initial speed and moving direction to the user.

6. The apparatus of claim 2, wherein the processor provides the user with a distance difference and direction between the target position and a final point of the moving trajectory determined according to the trajectory determining operation.

7. The apparatus of claim 1, wherein the processor supports a training mode in which one user practices golf and a game mode in which multiple users play a virtual golf game.

8. The apparatus of claim 7, wherein the game mode corresponds to a mode in which the multiple users located at remote positions play the virtual golf game based on the golf environment simulation device and the image acquisition module provided at a position of each user, and
the processor records scores, which are calculated as the multiple users play the virtual golf game, for each of the multiple users.

9. The apparatus of claim 1, wherein the image acquisition module includes a stereo camera, and
the processor is mounted on a smartphone and acquires three-dimensional position coordinates of the golf ball acquired by the stereo camera through wired or wireless communication to determine the initial speed and moving direction.

10. The apparatus of claim 1, wherein a user manipulation command and a result of shot in a golf practice and game are provided as voice.

11. A method of supporting virtual golf for a user based on a golf environment simulation device performed by a computing device and implemented such that a golf ball is physically hit and moved by the hit, the method comprising:
setting a virtual play environment of the virtual golf;
setting a hitting position at which the golf ball is hit and a target position at which the golf ball reaches in the set virtual play environment;
recognizing the golf ball through a pre-learned deep learning model based on an image of the golf ball acquired at a time point when the golf ball is hit on the golf environment simulation device;
analyzing an afterimage of the image of the golf ball to determine an initial speed and moving direction of the golf ball;
applying the hitting position, and the initial speed and moving direction to a predefined moving trajectory model to determine a moving trajectory of the golf ball; and
displaying the determined moving trajectory.

12. A computer program coupled to hardware and stored in a computer-readable recording medium to execute:
setting a virtual play environment of virtual golf;
setting a hitting position at which a golf ball is hit and a target position at which the golf ball reaches in the set virtual play environment;
recognizing the golf ball through a pre-learned deep learning model based on an image of the golf ball acquired at a time point when the golf ball is hit on a golf environment simulation device to determine an initial speed and moving direction of the golf ball, wherein the golf environment simulation device is a device implemented such that the golf ball is physically hit and moved by the hit;
applying the hitting position, and the initial speed and moving direction to a predefined moving trajectory model to determine a moving trajectory of the golf ball; and
displaying the determined moving trajectory.
